(19) United States
(12) Patent Application Publication
(10) Pub. No.: US 2010/0089904 A1
(43) Pub. Date: Apr. 15, 2010

(54) OVEN

(75) Inventor: Min Ho Yun, Changwon City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/523,442

(22) PCT Filed: Nov. 15, 2007
(86) PCT No.: PCT/KR07/05746

§ 371 Date: Dec. 24, 2009

(30) Foreign Application Priority Data
Apr. 12, 2007 (KR) 10-2007-0035864

(51) Int. Cl. F24C 7/00; F27D 11/00

(52) U.S. Cl. 219/400

(57) ABSTRACT

An oven is provided. The oven includes a wall and a convection assembly. The wall forms a cavity for cooking food. The convection assembly is provided outside the wall. Here, the wall includes a convection cover recessed toward the cavity to define a heating chamber, and at least a part of the convection assembly is located in the heating chamber.

### TECHNICAL FIELD

The present disclosure relates to an oven.

### BACKGROUND ART

Ovens generally cook food within a sealed chamber by heating the sealed chamber. Ovens are classified into gas and electric ovens based on the types of heat sources they employ.

A gas oven uses gas as fuel and provides it to a plurality of burners. Then, the gas oven heats the sealed chamber containing food with flames emanating from the burners. On the other hand, an electric oven operates a plurality of heaters by supplying electricity, and heats the sealed chamber containing food with heat generated by the heaters.

Compared to gas ovens, electric ovens heat the interior and the exterior of food simultaneously to shorten cooking time and improve thermal efficiency, and are also safer. Thus, there is an increasing preference for electric ovens.

An electric oven may include a convection assembly for transferring heat generated by a heater to the inside of a cavity. The convection assembly includes a convection heater, a convection fan that transfers heat generated by the convection heater to the inside of the cavity, and a convection cover that covers the convection heater.

### DISCLOSURE OF INVENTION

### Technical Problem

Embodiments provide an oven including a receiving space in a cavity for receiving a convection assembly.

Embodiments also provide an oven including a single wall forming the rear wall of a cavity.

### Technical Solution

In one embodiment, an oven includes: a wall forming a cavity for cooking food; and a convection assembly provided outside the wall, wherein the wall includes a convection cover recessed toward the cavity, to define a heating chamber, and at least a part of the convection assembly is located in the heating chamber.

In another embodiment, an oven includes: a wall forming a cavity; a convection heater provided outside the wall; a convection fan and a convection motor provided outside the wall; a convection cover formed from the wall, to form a heating chamber for heating the air by the convection heater; and a bracket covering the heating chamber.

In a further embodiment, an oven includes: a wall forming a cavity; a convection heater and a convection fan provided outside the wall; a convection cover recessed toward the cavity from the wall, to form a receiving space for receiving the convection heater and the convection fan; and a plurality of brackets covering the receiving space.

### Advantageous Effects

In the above-proposed embodiments, a rear wall defining the rear of a cavity is formed to be a single continuous surface, so that it becomes easy to clean the cavity, and user convenience can be improved.

As the rear wall is a single continuous surface, food residue cannot be remained thereon, thereby preventing unpleasant smells issuing from the cavity.

In addition, due to the single continuous surface, aesthetic characteristics are improved.

### BRIEF DESCRIPTION OF THE DRAWINGS

FIG. 1 is a perspective view of an oven with its door opened according to a first embodiment.

FIG. 2 is a side sectional view of an oven according to the first embodiment.

FIG. 3 is an exploded perspective view of a convection assembly according to the first embodiment.

FIG. 4 is a perspective view showing how a first bracket and a second bracket are coupled.

FIG. 5 is an exploded perspective view of a convection assembly according to a second embodiment.

### MODE FOR THE INVENTION

Detailed descriptions of embodiments will be given below with reference to the drawings.

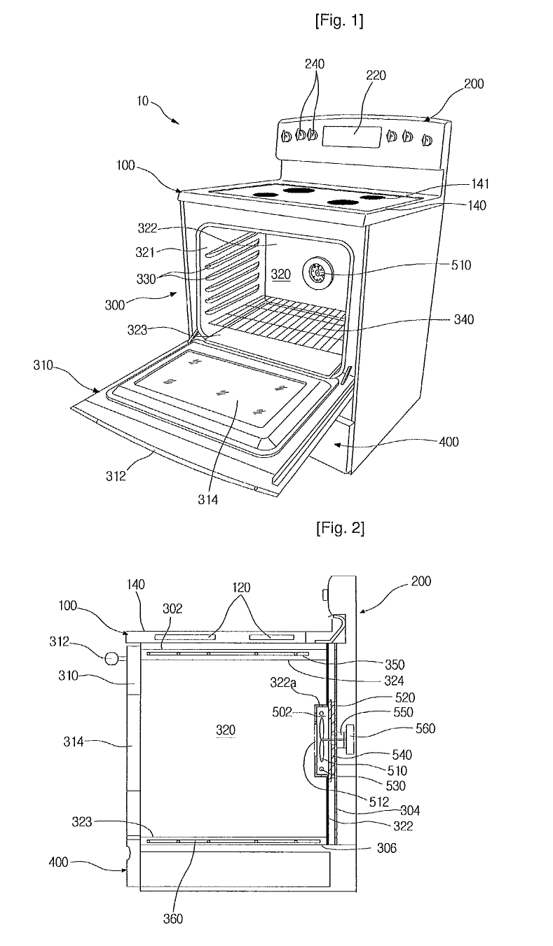

FIG. 1 is a perspective view of an oven with its door opened according to a first embodiment.

Referring to FIG. 1, an oven 10 includes a cooktop 100 disposed at the upper portion thereof and a cooking compartment 300 disposed below the cooktop 100.

In detail, the cooktop 100 includes a plurality of heating units 120 (FIG. 2), and a first top plate 140 provided on the heating units 120. The first top plate 140 defines a heating region 141 on which a cooking container is placed.

A control panel 200 is formed to protrude upward at the rear end of the cooktop 100, and is installed at the rear of the cooktop 100. The control panel 200 controls the operation of the oven 10. A display unit 220 is disposed at the front center of the control panel 200 and displays an operating state of the oven 10 and a cooking time of food.

A plurality of control units 240 are formed to protrude forward at either side of the display unit 220, for allowing a user to operate the oven 10. The display unit 220 may have a plurality of control buttons (not shown) for allowing the user to control the oven 10.

The cooking compartment 300 is disposed below the cooktop 100 to uniformly heat food at high temperature located in a sealed cooking chamber. The cooking chamber is opened or closed by a door 310.

A handle 312 is located at the front upper of the door 310. The user grasps the handle 312 and pivots the door 310 in forward and backward directions. A transparent window 314 is located at the center of the door 310 for enabling the user to identify the state of food being cooked inside the cooking compartment 300 or the inside state of the cooking compartment 300.

A cavity 320 for cooking food is formed inside the cooking compartment 300 by a plurality of walls.

Specifically, the walls includes sidewalls 321 that define both sides of the cavity 320, a rear wall 322 located at the rear ends of the sidewalls 321, a bottom wall 323 located at the lower ends of the sidewalls 321, and a top wall 324 (FIG. 2) located on the upper end of the sidewalls 321.

The cavity 320 may be formed by coupling separately made walls, or may have walls that are integrally formed. A convection assembly 500 (FIG. 4) is coupled at the rear wall 322 defining the rear of the cavity 320 in order to forcibly convect air in the cavity 320.

A rack 340 is provided in the cavity 320 to support food or a food container containing food. Both side ends of the rack 340 are supported by supporters 330 formed on the inner surfaces of the sidewalls 321. The supporter 330 is formed to protrude from the sidewall 321.

A storage compartment 400 is disposed below the cooking compartment 300, for warming or storing cooked foods. The storage compartment 400 slides in and out in forward and backward directions.

FIG. 2 is a side sectional view of an oven according to the first embodiment.

Referring to FIG. 2, the cooking compartment 300 includes a top plate 302 forming the top thereof, side plates (not shown) forming sides, a rear plate 304 forming the rear, and a bottom plate 306 forming the bottom.

A plurality of heaters are installed the inner space of the cooking compartment 300 formed by the plates.

Specifically, a top heater 350 is provided between the top wall 324 and the top plate 302 to radiate heat downward, and a bottom heater 360 is provided between the bottom wall 323 and the bottom plate 306 to radiate heat upward.

The top heater 350 and the bottom heater 360 may be a sheath heater or a halogen heater.

A convection cover 322a is formed on the rear wall 322. The convection cover 322a is formed by a portion of the rear wall 322 protruding in a forward direction. The forward direction indicates a direction toward the door 310.

The convection cover 322a is circular when viewed from the front.

The convection cover 322a forms a heating chamber 502 for receiving a convection heater 530 and a convection fan 510. The heating chamber 502 is formed outside the rear wall 322. The heating chamber 502 provides a space for heating the air of the cavity 320 as well as a receiving space for receiving the convection heater 530 and the convection fan 510.

The convection assembly 500 is provided outside the rear wall 322. The convection assembly 500 forcibly circulates the air of the cavity 320, so that food disposed in the cavity 320 is uniformly cooked.

The convection assembly 500 includes a convection motor 560, the convection fan 510, and the convection heater 530. The convection motor 560 is mounted outside the rear plate 304 that forms the rear of the cooking compartment 300. The convection fan 510 is connected to the convection motor 560 and rotates by receiving a rotational force generated by the convection motor 560. The convection heater 530 is provided around the outer periphery of the convection fan 510. The convection fan 510 and the convection heater 530 are disposed in the heating chamber 502.

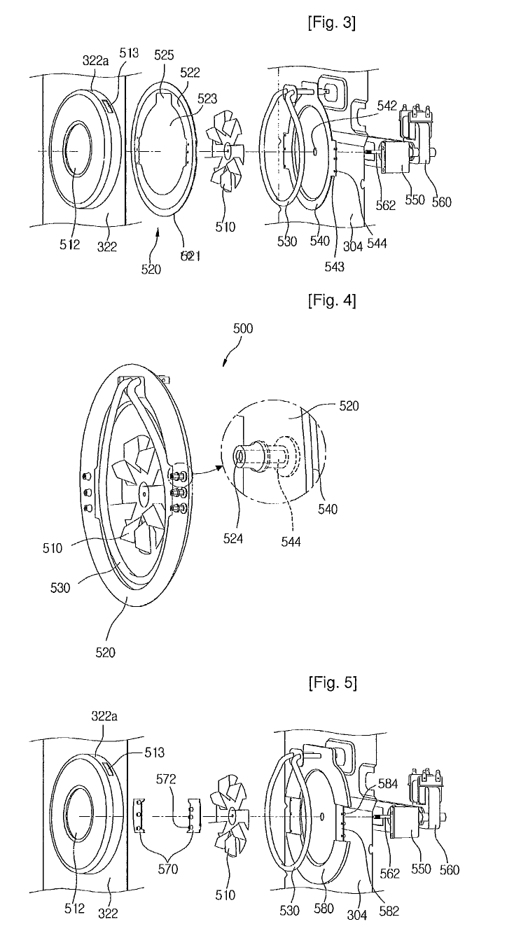

FIG. 3 is an exploded perspective view of a convection assembly according to the first embodiment.

Referring to FIG. 3, the convection cover 332a is formed to protrude forward from the rear wall 322. A suctioning hole 512 is formed at the front of the convection cover 322a, and a discharge hole 513 is formed at the side (or the outer periphery) of the convection cover 322a.

The heating chamber 502 located outside the convection cover 322a receives the convection fan 510 and the convection heater 530. The convection fan 510 suctions the air of the cavity 320 through the suctioning hole 512 and transfers it into the heating chamber 502. The convection heater 530 heats the transferred air.

The convection heater 530 is annular and is separated from the peripheral edge of the convection fan 510 by a predetermined distance.

A first bracket 520 is fixed to the rear of the rear wall 322. The first bracket 520 is coupled to the rear of the rear wall 322 by welding. The overall shape of the first bracket 520 is annular, and the outer circumference of the first bracket 520 is greater than the diameter of the convection cover 322a.

After the convection fan 510 and the convection heater 530 are received by the heating chamber 502, a second bracket 540 that covers the heating chamber 502 is mounted on the first bracket 520. The second bracket 540 has a disc shape, and its center portion with a predetermined thickness is recessed rearward.

A shaft through-hole 542, through which a shaft 562 of the convection motor 560 passes, is provided at the central portion of the second bracket 540. Although not shown, the central portion of the rear plate 304 also has a through-hole for the shaft 562 to pass through.

The first bracket 520 has a through-hole 523 for the penetration of the shaft 562. The diameter of the through-hole 523 is less than the diameter of the convection cover 322a. When the first bracket 520 is fixed to the rear wall 322, one surface of the first bracket 520 contacts the rear wall 322 closely, and the other surface covers the heating chamber 502.

That is, the first bracket 520 may be divided into a fixing portion 521 that is fixed to the rear wall 322 and a sealing portion 522 that seals a part of the heating chamber 502. The through-hole 523 is provided in the sealing portion 522. A heater through portion 525 passing through a part of the convection heater 530 is provided in the fixing portion 521.

Using a coupling member, the second bracket 540 is coupled to the first bracket 520 fixed to the rear wall 322. Specifically, the second bracket 540 is coupled to the sealing portion 522.

The rear plate 304 forming the rear of the cooking compartment 300 is provided behind the second bracket 540, and the convection motor 560 is mounted behind the rear plate 304. The convection motor 560 is mounted behind the rear plate 304 by a motor bracket 550, and the shaft 562 is passed through the motor bracket 550, the rear plate 304, and the second bracket 540, to be coupled to the convection fan 510.

As described above, since the convection cover 322a protrudes forward from the rear wall 322 in the present embodiment, the rear wall 322 is formed as a single, continuous surface.

FIG. 4 is a perspective view showing how a first bracket and a second bracket are coupled.

Referring to FIG. 4, first coupling portions 524 coupled to the second bracket 540 by a coupling member are provided in the fixing portion 522 of the first bracket 520. The first coupling portion 524 protrudes forward from the fixing portion 522.

As the first coupling portion 524 protrudes forward, the rear surface of the first bracket 520 and the front surface of the second bracket 540 may be coupled closely to each other.

When the first bracket 520 is fixed to the rear wall 322, the first coupling portion 524 is located in the heating chamber 502.

Also, the outer circumference of the second bracket 540 is greater than the diameter of the through-hole 523 formed in the sealing portion 522. Accordingly, when the second bracket 540 is coupled to the first bracket 520, the second bracket 540 covers the through-hole 523, and at least a part thereof is pressed against the sealing portion 522.

A coupling part 543 coupled to the first bracket 520 is formed in the second bracket 540, and second coupling portions 544 coupled to the first bracket 520 by a coupling member are formed on the coupling part 543. The second coupling portion 544 protrudes rearward from the second bracket 540. In other words, the second coupling portion 544 protrudes in a direction opposite to a direction in which the first coupling portion 524 of the first bracket 520 protrudes. Also, the second coupling portion 544 corresponds in position to the first coupling portion 524.

The motor bracket 550, the second bracket 540, and the first bracket 520 may be coupled together by one coupling member. That is, a coupling member coupled to the motor bracket 550 may be coupled to the second coupling portion 544 and the first coupling portion 524.

Hereinafter, the operation of the cooking compartment 300 with the above-configured convection assembly will be described.

After a user grasps the handle 312 and pivots the door 310 forward, the user puts food or a food container containing food into the cavity 320. Then, the user pivots the door 310 backward.

Thereafter, the user manipulates the control panel 200 to operate the cooking compartment 300. Then, the top heater 350 and the bottom heater 360 operate, and the convection heater 530 and the convection motor 560 operate.

When the convection motor 560 operates, the convection fan 510 rotates. Through the rotation of the convection fan 510, the air in the cavity 320 is transferred into the heating chamber 502 via the suctioning hole 512 provided in the convection cover 322a.

The transferred air is discharged radially by the rotation of the convection fan 510 and the discharged air is transferred into the cavity 320 via the discharge hole 513 of the convection cover 322a.

At this time, the radially discharged air is heated by the convection heater 530 and transferred into the cavity 320 via the discharge hole 513.

The air discharged via the discharge hole 513 flows toward the forward of the cavity 320, and is then re-transferred into the heating chamber 502 via the suctioning hole 512. As a result, the air of the cavity 320 circulates continuously.

As the air of the cavity 320 circulates continuously, food within the cavity 320 is cooked uniformly.

FIG. 5 is an exploded perspective view of a convection assembly according to a second embodiment.

In the second embodiment, elements other than the shapes of a first bracket and a second bracket are equal to corresponding elements of the first embodiment. Thus, only characteristic features of the second embodiment will be described, and features already described by the first embodiment will be omitted.

Referring to FIG. 5, a convection assembly in the second embodiment includes a plurality of first brackets 570 and a second bracket 580 coupled to the first brackets 580. The first bracket 570 has a rectangular plate shape, and includes a first coupling portion 572. When the first bracket 570 is fixed to a rear wall 322, the first coupling portion 572 is located in a heating chamber 502 (FIG. 2).

A coupling portion 582 is provided in the second bracket 580, to be coupled to the first bracket 570. The coupling portion 582 corresponds in shape to the first bracket 570. In other words, the coupling portion 582 is recessed rearward the second bracket 580. A second coupling portion 584 is provided at the rear surface of the coupling portion 582.

1. An oven comprising:
a wall forming a cavity for cooking food; and
a convection assembly provided outside the wall,
wherein the wall comprises a convection cover recessed toward the cavity to define a heating chamber, and at least a part of the convection assembly is located in the heating chamber.

2. The oven according to claim 1, wherein the convection assembly comprises a convection heater in the heating chamber and a convection fan in the heating chamber.

3. The oven according to claim 2, further comprising:
a first bracket fixed outside the wall;
wherein a part of the first bracket covers the heating chamber.

4. The oven according to claim 3, wherein the first bracket comprises:
a fixing portion fixed to the wall; and
a sealing portion sealing a part of the heating chamber.

5. The oven according to claim 4, wherein the fixing portion is welded to the wall.

6. The oven according to claim 3, further comprising:
a second bracket covering the heating chamber, and coupled to the first bracket.

7. The oven according to claim 6, wherein the first bracket comprises a first coupling portion protruding in a predetermined direction, and the second bracket comprises a second coupling portion protruding in a direction opposite to the predetermined direction.

8. The oven according to claim 7, wherein the first coupling portion is received in the heating chamber.

9. The oven according to claim 6, wherein the first bracket and the second bracket are coupled by a single coupling member.

10. The oven according to claim 6, wherein the second bracket comprises a coupling surface that is coupled to the first bracket.

11. The oven according to claim 3, wherein the first bracket comprises a heater through portion passed through the convection heater.

12. An oven comprising:
a wall forming a cavity;
a convection heater provided outside the wall;
a convection fan and a convection motor provided outside the wall;
a convection cover formed from the wall, to form a heating chamber for heating air with the convection heater; and
a bracket covering the heating chamber.

13. The oven according to claim 12, wherein the convection cover comprises a suctioning hole through which air in the cavity is transferred to the heating chamber, and a discharge hole through which air in the heating chamber is transferred to the cavity.

14. The oven according to claim 12, wherein the bracket comprises:
a first bracket fixed outside the wall; and
a second bracket coupled to the first bracket;
wherein the first bracket and the second bracket respectively define a through-hole through which a shaft of the convection motor passes.

15. The oven according to claim 14, wherein the first bracket is fixed to the wall by welding, and the second bracket is coupled to the first bracket through a coupling member.

16. The oven according to claim 14, wherein the first bracket comprises:
a fixing portion fixed to the wall; and
a sealing portion sealing a part of the heating chamber.

17. The oven according to claim 12, further comprising:
a motor bracket for fixing the convection motor;
wherein the motor bracket is coupled to the bracket through a coupling member.

18. An oven comprising:
a wall forming a cavity;
a convection heater and a convection fan provided outside the wall;
a convection cover recessed toward the cavity from the wall, to form a receiving space that receives the convection heater and the convection fan; and
a plurality of brackets sealing the receiving space.

19. The oven according to claim 18, wherein the bracket comprises:
a first bracket fixed outside the wall; and
a second bracket coupled to the first bracket.

20. The oven according to claim 19, further comprising:
a convection motor rotating the convection fan;
wherein a shaft of the convection motor passes through the second bracket.
